(19) United States
(12) Patent Application Publication
(10) Pub. No.: US 2014/0078031 A1
(43) Pub. Date: Mar. 20, 2014

(54) ORGANIC LIGHT EMITTING DISPLAY AND METHOD OF DRIVING THE SAME

(71) Applicants: Hwan-Soo JANG, Yongin-City (KR); Yang-Wan KIM, Yongin-City (KR); Jin-Tae JEONG, Yongin-City (KR)

(72) Inventors: Hwan-Soo JANG, Yongin-City (KR); Yang-Wan KIM, Yongin-City (KR); Jin-Tae JEONG, Yongin-City (KR)

(21) Appl. No.: 13/762,592

(22) Filed: Feb. 8, 2013

(30) Foreign Application Priority Data
Sep. 20, 2012 (KR) 10-2012-0104508

(51) Int. Cl. G09G 3/32

(52) U.S. Cl. CPC G09G 3/3208
USPC 345/83

(57) ABSTRACT

A method of driving an organic light emitting display includes dividing one frame into a plurality of subfields, setting a plurality of pixels to include first pixels positioned in odd horizontal lines and second pixels positioned in even horizontal lines, and setting pixels that realize low grayscales in an emission state in one of the plurality of subfields, such that the first pixels have emission states in different subfields than emission states of the second pixels, when the low grayscales are realized.

### CROSS-REFERENCE TO RELATED APPLICATION

This application claims priority under 35 USC §119 to and the benefit of Korean Patent Application No. 10-2012-0104508, filed on Sep. 20, 2012, in the Korean Intellectual Property Office, the entire content of which is incorporated herein by reference.

### BACKGROUND

1. Field

Example embodiments relate to an organic light emitting display and a method of driving the same, and more particularly, to an organic light emitting display capable of improving display quality and a method of driving the same.

2. Description of the Related Art

Recently, various flat panel displays (FPD) with reduced weight and volume, e.g., as compared to cathode ray tube (CRT) displays, have been developed. The FPDs include, e.g., liquid crystal displays (LCDs), field emission displays (FEDs), plasma display panels (PDPs), and organic light emitting displays.

Among the FPDs, the organic light emitting displays display images using organic light emitting diodes (OLEDs) that generate light by re-combination of electrons and holes. The organic light emitting display exhibits high response speed and is driven with low power consumption.

### SUMMARY

Example embodiments provide an organic light emitting display capable of improving display quality and a method of driving the same.

In order to achieve the foregoing and/or other aspects of the example embodiments, there is provided method of driving an organic light emitting display including dividing one frame into a plurality of subfields, setting a plurality of pixels to include first pixels positioned in odd horizontal lines and second pixels positioned in even horizontal lines, and setting pixels that realize low grayscales in an emission state in one of the plurality of subfields, such that the first pixels have emission states in different subfields than emission states of the second pixels, when the low grayscales are realized.

The first pixels that realize the low grayscales and the second pixels that realize the low grayscales may be set in the emission state with at least one subfield interposed therebetween. The low grayscales may mean grayscales of no more than a predetermined reference grayscale and the reference grayscale is set as one of grayscales 20 to 100. The one frame may include a first subfield, a second subfield, a third subfield, and a fourth subfield. The first pixels that realize the low grayscales may be set in the emission state in the first subfield. The second pixels that realize the low grayscales may be set in the emission state in the third subfield. Scan signals may be supplied to odd scan lines in scan periods of the first subfield and the second subfield. Scan signals may be supplied to even scan lines in scan periods of the third subfield and the fourth subfield. The first subfield and the third subfield may be set to have the same period. The second subfield and the fourth subfield may be set to have the same period. The first to fourth subfields may be set to have the same period. Data signals corresponding to various grayscales may be supplied in the scan periods of the first subfield to the fourth subfield. Pixels that realize grayscales that exceed the low grayscales may be set in the emission state in the one frame.

In order to achieve the foregoing and/or other aspects of the example embodiments, there is also provided an organic light emitting display, including a scan driver configured to supply scan signals to odd scan lines in scan periods of odd subfields of one frame and to supply scan signals to even scan lines in scan periods of even subfields of the one frame, the odd and even subfields being different from each other, a data driver configured to supply data signals to data lines in synchronization with the scan signals, and pixels positioned at intersections of the scan lines and the data lines, the pixels including first pixels positioned in odd horizontal lines, the first pixels being configured to realize low grayscales, and second pixels positioned in even horizontal lines, the second pixels being configured to realize low grayscales and to emit light in different subfields than the first pixels.

The first pixels and the second pixels may emit light with at least one subfield interposed. The low grayscales may mean grayscales of no more than a predetermined reference grayscale and the reference grayscale is set as one of grayscales 20 to 100. The one frame includes a first subfield, a second subfield, a third subfield, and a fourth subfield. The first pixels may be set in the emission state only in the first subfield. The second pixels are set in the emission state only in the third subfield. The scan driver may supply scan signals to the odd scan lines in the scan periods of the first subfield and the second subfield and may supply scan signals to the even scan lines in the scan periods of the third subfield and the fourth subfield. The first subfield and the third subfield may be set to have the same period. The second subfield and the fourth subfield may be set to have the same period. The first to fourth subfields may be set to have the same period. The data driver may supply data signals corresponding to various grayscales in the scan periods of the first subfield to the fourth subfield. Pixels that realize grayscales that exceed the low grayscales may be set in the emission state in the one frame.

### BRIEF DESCRIPTION OF THE DRAWINGS

The accompanying drawings, together with the specification, illustrate exemplary embodiments, and, together with the description, serve to explain the principles of the example embodiments.

FIG. 1 is a view illustrating one frame of an organic light emitting display according to an embodiment;

FIG. 2 is a view illustrating an embodiment of an emission state of one frame when low scales are realized;

FIG. 3 is a view illustrating pixels that emit light in the frame of FIG. 2; and

FIG. 4 is a view illustrating an organic light emitting display according to an embodiment.

### DETAILED DESCRIPTION

Korean Patent Application No. 10-2012-0104508, filed on Sep. 20, 2012, in the Korean Intellectual Property Office, and entitled: “Organic Light Emitting Display Device and Driving Method Thereof” is incorporated by reference herein in its entirety.

Hereinafter, an organic light emitting display and a method of driving the same will be described in detail with reference to FIGS. 1 to 4, in which preferred embodiments are illustrated.

FIG. 1 is a view illustrating one frame of an organic light emitting display according to an embodiment.

Referring to FIG. 1, one frame 1F of an organic light emitting display according to an embodiment is divided into a plurality of subfields, e.g., into at least four subfields SF1 to SF4. Each of the subfields SF1 to SF4 is divided into a scan period “a” and an emission period “b”.

In the scan period “a”, scan signals are supplied to odd or even scan lines and data signals are supplied to data lines in synchronization with the scan signals.

For example, in the scan periods a(o) of the first subfield SF1 and the second subfield SF2, the scan signals are sequentially supplied to odd scan lines. In this case, in the first subfield SF1 and the second subfield SF2, pixels positioned in odd horizontal lines are selected so that the data signals are supplied to the pixels positioned in the odd horizontal lines.

In the scan periods a(e) of the third subfield SF3 and the fourth subfield SF4, the scan signals are sequentially supplied to even scan lines. In this case, in the third subfield SF3 and the fourth subfield SF4, pixels positioned in even horizontal lines are selected so that the data signals are supplied to the pixels positioned in the even horizontal lines.

In the emission period “b”, pixels emit light in response to the data signals supplied in the scan period “a”. That is, in the emission period “b”, the pixels generate light components of the same brightness or light components of different brightness to correspond to the data signals supplied in the scan period “a”.

According to the example embodiments, the emission time of the pixels that realize low grayscales is controlled, so that the threshold voltages of driving transistors may be stably compensated for. For example, the pixels positioned in the odd horizontal lines to realize the low grayscales emit light in the first subfield SF1 period and the pixels positioned in the even horizontal lines to realize the low grayscales emit light in the third subfield SF3.

Specifically, first pixels positioned in the odd horizontal lines to realize the low grayscales, e.g., thirty-one (31) grayscales, emit light only in the first subfield SF1. In this case, higher current than in a conventional organic light emitting display flows in the first pixels, so that the thirty-one (31) grayscales may be realized for a short time SF1. Then, the threshold voltages of the driving transistors included in the first pixels are stably compensated for to correspond to the high current in the first pixels, so that display quality may be improved in a low scale region.

Second pixels positioned in the even horizontal lines to realize the low grayscales emit light only in the third subfield SF3. In this case, higher current than in a conventional organic light emitting display flows in the second pixels so that the low grayscales may be realized for a short time. Then, the threshold voltages of the driving transistors included in the second pixels are stably compensated for to correspond to the high current in the second pixels, so that display quality may be improved in the low scale region.

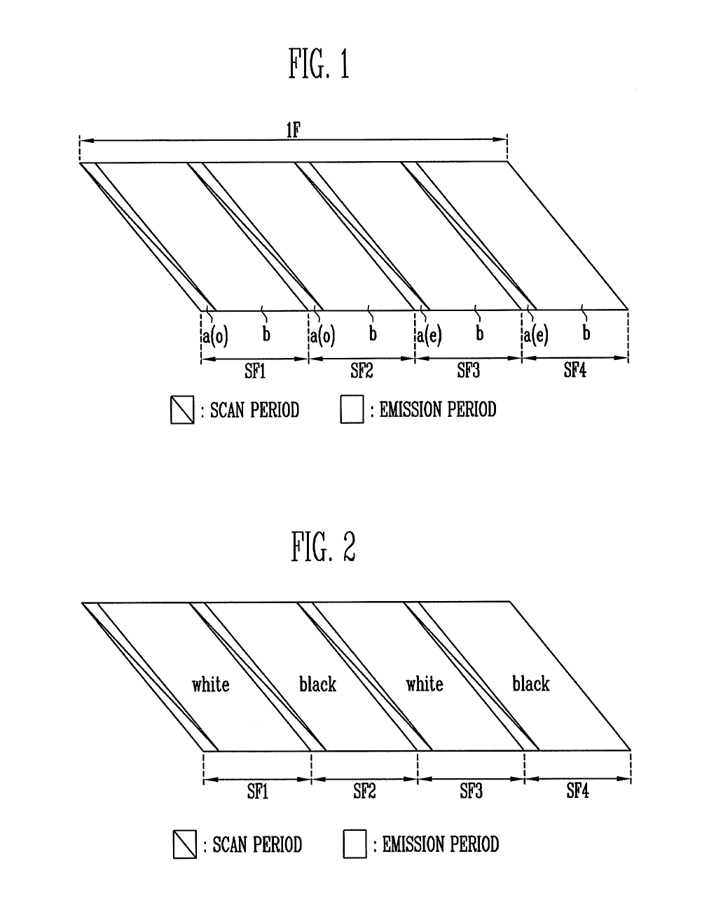

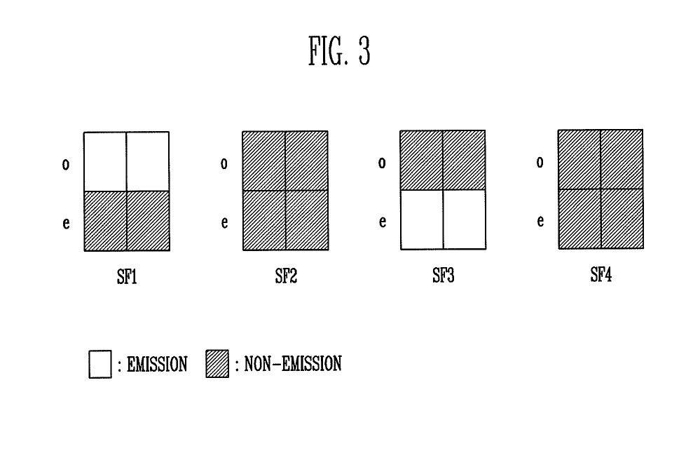

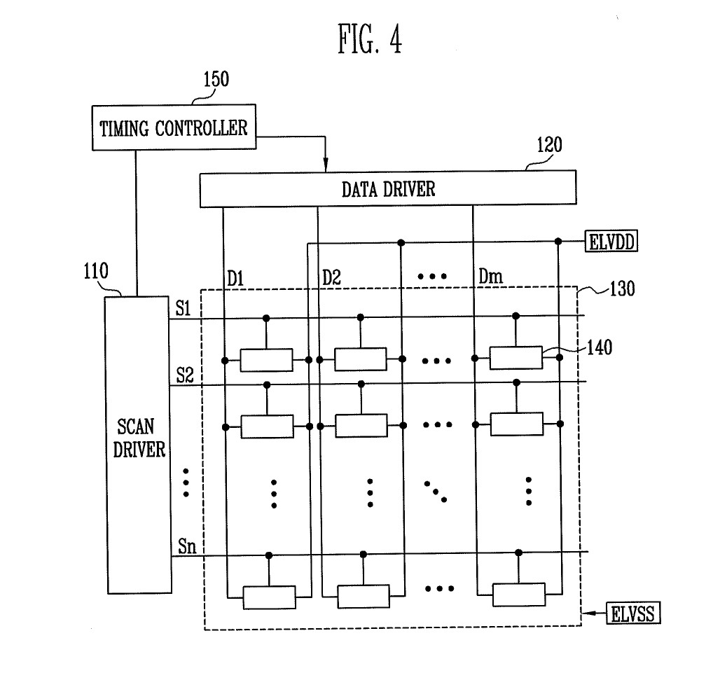

On the other hand, when brightness components of the low grayscales are realized in one frame 1 F, as illustrated in FIG. 2, light is emitted in the first subfield SF1 and the third subfield SF3, and light is not emitted in the second subfield SF2 and the fourth subfield SF4. Here, as illustrated in FIG. 3, the pixels positioned in the odd horizontal lines “o” emit light in the first subfield SF1, and the pixels positioned in the even horizontal lines “e” emit light in the third subfield SF3.

In this case, the non-emission regions SF2 and SF4 are temporally separated in one frame 1F, so that it is possible to prevent flicker from being generated. That is, according to the example embodiments, the pixels that realize the low grayscales are controlled to generate light with high brightness for a short time, so that it is possible to realize brightness in which the threshold voltages are compensated for and the non-emission regions SF2 and SF4 are temporally separated so that it is possible to prevent flicker from being generated.

According to the example embodiments, the low grayscales may be experimentally determined in consideration of the size and resolution of a panel. For example, when 256 grayscales are realized by the pixels, a reference grayscale of the low grayscales may be set as one of the grayscales 20 to 100. For example, when the grayscale 64 is set as the reference grayscale of the low grayscales, pixels that realize grayscales of no more than 64 emit light only in the first subfield SF1 or the third subfield SF3. In this case, pixels that realize the low grayscales receive data signals corresponding to the grayscales 1 to 64 in the first subfield SF1 or the third subfield SF3.

Further, according to the example embodiments, when grayscales that exceed the low grayscales, i.e., high grayscales, are realized, the pixels emit light in one frame. That is, when the high grayscales are realized by the pixels, a current of no less than a predetermined current flows through the pixels, so that an image of the brightness in which the threshold voltages of the driving transistors are compensated for may be realized. Therefore, according to the example embodiments, the pixels that realize the high grayscales are set in an emission state in one frame 1F. In this case, in the pixels that realize the high grayscales, a current for representing brightness is not increased in comparison with a conventional art. That is, when the high grayscales are realized, the pixels are set in the emission state in one frame so that it is possible to prevent life of the organic light emitting display from being reduced by an increase in the current.

In describing operation processes, in the scan period a(o) of the first subfield SF1, the scan signals are sequentially supplied to the odd scan lines and the data signals are supplied to the data lines. Here, the voltage values of the data signals supplied to the pixels that realize the low grayscales are controlled so that an image with a desired brightness may be realized, e.g., only, in the first subfield SF1. The voltage values of the data signals supplied to the pixels that realize the high grayscales are controlled so that the image with the desired brightness may be realized in one frame to correspond to the grayscales of the pixels. The pixels that receive the data signals in the scan period a(o) of the first subfield SF1 emit light in the emission period “b” to correspond to the data signals.

In the scan period a(o) of the second subfield SF2, the scan signals are sequentially supplied to the odd scan lines and the data signals are supplied to the data lines. Here, data signals corresponding to “black” are supplied to the pixels that realize the low grayscales, and data signals corresponding to the grayscales are supplied to the pixels that realize the high grayscales. Accordingly, in the second subfield SF2, the pixels that realize the low grayscales are set in the non-emission state, and the pixels that realize the high grayscales are set in the emission state.

In the scan period a(e) of the third subfield SF3, the scan signals are sequentially supplied to the even scan lines and the data signals are supplied to the data lines. Here, the voltage values of the data signals supplied to the pixels that realize the low grayscales are controlled so that an image with a desired brightness may be realized in the third subfield SF3. The voltage values of the data signals supplied to the pixels that realize the high grayscales are controlled so that the image with the desired brightness may be realized in one frame to correspond to the grayscales of the pixels. The pixels that receive the data signals in the scan period a(e) of the third subfield SF3 emit light in the emission period “b” to correspond to the data signals. On the other hand, the pixels positioned in the odd horizontal line to realize the high grayscales do not receive data signals in the third subfield SF3 so that the pixels are set in the emission state, e.g., the pixels positioned in the odd horizontal lines to realize the high grayscales maintain the emission state in the third subfield SF3 and the fourth subfield SF4.

In the scan period a(e) of the fourth subfield SF4, the scan signals are sequentially supplied to the even scan lines and the data signals are supplied to the data lines. Here, the data signals corresponding to “black” are supplied to the pixels that realize the low grayscales, and the data signals corresponding to the grayscales are supplied to the pixels that realize the high grayscales. Then, the pixels that realize the low grayscales are set in the non-emission state and the pixels that realize the high grayscales are set in the emission state in the fourth subfield SF4, e.g., the pixels positioned in the even horizontal lines to realize the high grayscales maintain the emission state in the first subfield SF1 and the second subfield SF2 of the next frame.

As described above, according to example embodiments, the emission time of the pixels that realize the low grayscales is minimized, so that a high current flows through the pixels and a low grayscale image, in which the threshold voltages of the driving transistors are compensated for, may be realized. In addition, according to the example embodiments, when the high grayscales are realized, the pixels are controlled to emit light in one frame, so that it is possible to prevent the life of the organic light emitting display from being reduced by the increase in the current.

That is, according to the example embodiments, the periods of the subfields included in one frame 1F may vary. The subfields that realize the low grayscales, e.g., the first subfield SF1 and the third subfield SF3, are set to have the same period so that the grayscales may be stably realized. The subfields in which the pixels that realize the low grayscales are set in the non-emission state, e.g., the second subfield SF2 and the fourth subfield SF4, are set to have the same period. In this case, the time at which the low grayscales are realized is reduced when the period of the second subfield SF2 is set to be longer than the period of the first subfield SF1 and is increased when the period of the second subfield SF2 is set to be shorter than the period of the first subfield SF1.

According to the example embodiments, the periods of the subfields included in one frame 1F are experimentally determined in consideration of the resolution and size of the panel, so that display quality may be improved. For example, the periods of the first subfield SF1 to the fourth subfield SF4 may be set to be the same. In this case, the pixels that realize the low grayscales are set in the emission state for about ¼ of the period of one frame 1F.

FIG. 4 is a view illustrating the organic light emitting display according to an embodiment.

Referring to FIG. 4, the organic light emitting display according to an embodiment includes a pixel unit 130 with pixels 140 positioned at intersections of the scan lines S1 to Sn and the data lines D1 to Dm, a scan driver 110 for driving the scan lines S1 to Sn, a data driver 120 for driving the data lines D1 to Dm, and a timing controller 150 for controlling the scan driver 110 and the data driver 120.

The timing controller 150 controls the scan driver 110 and the data driver 120 to correspond to synchronizing signals supplied from the outside. The timing controller 150 controls the grayscales of data items supplied from the outside and supplies the data items to the data driver 120. Here, when the timing controller 150 realizes the low grayscales, the grayscales of the data items are controlled so that desired brightness may be realized in one subfield SF1 or SF3. When the controller 150 realizes the high grayscales, the grayscales of the data items are controlled so that the desired brightness may be realized in one frame.

The scan driver 110 supplies the scan signals to the odd scan lines S1, S3, . . . in the scan periods a(o) of the first subfield SF1 and the second subfield SF2. Then, the scan driver 110 supplies the scan signals to the even scan lines S2, S4, . . . in the scan periods a(e) of the third subfield SF3 and the fourth subfield SF4.

The data driver 120 generates the data signals to correspond to the data items supplied from the timing controller 150 and supplies the generated data signals to the data lines D1 to Dm in the scan periods “a” of the subfields SF1 to SF4.

Here, the data driver 120 supplies data signals corresponding to the low grayscales to the first pixels positioned in the odd horizontal lines and supplies data signals corresponding to the high grayscales to the second pixels in the first subfield SF1. The data driver 120 supplies the data signals corresponding to “black” to the first pixels and supplies the data signals corresponding to the high grayscales to the second pixels in the second subfield SF2.

In addition, the data driver 120 supplies the data signals corresponding to the low grayscales to the third pixels positioned in the even horizontal lines and supplies the data signals corresponding to the high grayscales to the fourth pixels in the third subfield SF3. The data driver 120 supplies the data signals corresponding to “black” to the third pixels and supplies the data signals corresponding to the high grayscales to the fourth pixels in the fourth subfield SF4.

The pixel unit 130 receives the first power supply ELVDD and the second power supply ELVSS from the outside to supply the first power supply ELVDD and the second power ELVSS to the pixels 140. The pixels 140 generate light components with predetermined brightness components while controlling the amounts of currents that flow from the first power supply ELVDD to the second power supply ELVSS via OLEDs (not shown) to correspond to the data signals. Here, the structure of the pixels 140 may be any suitable structures that compensate for the threshold voltages of the driving transistors.

By way of summary and review, in the organic light emitting display according to example embodiments, when the low grayscales are realized, the pixels emit light only in a partial period of one frame period, so that the threshold voltages of the driving transistors may be stably compensated for. In addition, the pixels positioned in the odd and even horizontal lines to realize the low grayscales are set to be in the non-emission state at different times, so that it is possible to prevent or substantially minimize generation of flickers.

In contrast, in the conventional organic light emitting display, spots and flickers may be observed in a low brightness region. For example, while the conventional organic light emitting display may compensate for the threshold voltage of the driving transistor in each of the pixels by a circuit, the threshold voltage of the driving transistor in the low bright region is not correctly compensated for due to low current therethrough, thereby generating spots.

While the example embodiments has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of driving an organic light emitting display, the method comprising:
dividing one frame into a plurality of subfields;
setting a plurality of pixels to include first pixels positioned in odd horizontal lines and second pixels positioned in even horizontal lines; and
setting pixels that realize low grayscales in an emission state in one of the plurality of subfields, such that the first pixels have emission states in different subfields than emission states of the second pixels, when the low grayscales are realized.

2. The method as claimed in claim 1, wherein setting the first and second pixels to have emission states in different subfields includes setting the first pixels that realize the low grayscales and the second pixels that realize the low grayscales in emission states with at least one subfield interposed therebetween.

3. The method as claimed in claim 1, wherein the low grayscales are grayscales below a predetermined reference grayscale, the reference grayscale being set as one of grayscales 20 to 100.

4. The method as claimed in claim 1, wherein dividing the one frame into a plurality of subfields includes dividing the one frame into at least a first subfield, a second subfield, a third subfield, and a fourth subfield.

5. The method as claimed in claim 4, wherein the first pixels that realize the low grayscales are set in the emission state in the first subfield, and the second pixels that realize the low grayscales are set in the emission state in the third subfield.

6. The method as claimed in claim 5, wherein scan signals are supplied to odd scan lines in scan periods of the first subfield and the second subfield, and scan signals are supplied to even scan lines in scan periods of the third subfield and the fourth subfield.

7. The method as claimed in claim 5, wherein the first subfield and the third subfield are set to have the same period.

8. The method as claimed in claim 5, wherein the second subfield and the fourth subfield are set to have the same period.

9. The method as claimed in claim 4, wherein the first subfield to the fourth subfield are set to have the same period.

10. The method as claimed in claim 4, wherein data signals corresponding to various grayscales are supplied in the scan periods of the first subfield to the fourth subfield.

11. The method as claimed in claim 1, wherein pixels that realize grayscales that exceed the low grayscales are set in the emission state in the one frame.

12. An organic light emitting display, comprising:
a scan driver configured to supply scan signals to odd scan lines in scan periods of odd subfields of one frame and to supply scan signals to even scan lines in scan periods of even subfields of the one frame, the odd and even subfields being different from each other;
a data driver configured to supply data signals to data lines in synchronization with the scan signals; and
pixels positioned at intersections of the scan lines and the data lines, the pixels including:
first pixels positioned in odd horizontal lines, the first pixels being configured to realize low grayscales, and
second pixels positioned in even horizontal lines, the second pixels being configured to realize low grayscales and to emit light in different subfields than the first pixels.

13. The organic light emitting display as claimed in claim 12, wherein emission states of the first pixels and the second pixels are separated by at least one subfield of the one frame.

14. The organic light emitting display as claimed in claim 12, wherein the low grayscales are grayscales below a predetermined reference grayscale, the reference grayscale being set as one of grayscales 20 to 100.

15. The organic light emitting display as claimed in claim 12, wherein the one frame includes at least four subfields, the at least four subfields including first through fourth subfields.

16. The organic light emitting display as claimed in claim 15, wherein the first pixels are set in the emission state only in the first subfield, and the second pixels are set in the emission state only in the third subfield.

17. The organic light emitting display as claimed in claim 16, wherein the scan driver is configured to supply scan signals to the odd scan lines in the scan periods of the first subfield and the second subfield and to supply scan signals to the even scan lines in the scan periods of the third subfield and the fourth subfield.

18. The organic light emitting display as claimed in claim 16, wherein the first subfield and the third subfield are set to have the same period.

19. The organic light emitting display as claimed in claim 16, wherein the second subfield and the fourth subfield are set to have the same period.

20. The organic light emitting display as claimed in claim 16, wherein the first subfield to the fourth subfield are set to have the same period.

21. The organic light emitting display as claimed in claim 16, wherein the data driver is configured to supply data signals corresponding to various grayscales in the scan periods of the first subfield to the fourth subfield.

22. The organic light emitting display as claimed in claim 16, wherein pixels that realize grayscales higher than the low grayscales are set in an emission state in the one frame.
